(19) United States
(12) Patent Application Publication
(10) Pub. No.: US 2025/0042758 A1
(43) Pub. Date: Feb. 6, 2025

(54) TRANSLUCENT BULK CARBONATE AND ITS PRODUCTION

(71) Applicant: THE UNIVERSITY OF BRITISH COLUMBIA, Vancouver (CA)

(72) Inventors: Curtis BERLINGUETTE, Vancouver (CA); Zishuai ZHANG, Vancouver (CA)

(21) Appl. No.: 18/718,609

(22) PCT Filed: Dec. 14, 2022
(86) PCT No.: PCT/CA2022/051821

§ 371 Date: Jun. 11, 2024

Related U.S. Application Data
(60) Provisional application No. 63/265,461, filed on Dec. 15, 2021.

(51) Int. Cl. C01F 11/18; B01D 53/14; B01D 53/62; B01D 53/78; C09D 5/16; C09D 127/18; C09K 9/00

(52) U.S. Cl. CPC C01F 11/183; B01D 53/1475; B01D 53/62; B01D 53/78; C09D 5/1668; C09D 127/18; C09K 9/00; B01D 2257/504; B01D 2258/0283; B01D 2258/06; C01P 2002/02

(57) ABSTRACT

Particles of a carbonate compound, such as calcium carbonate, in an amorphous form may be precipitated from solution, freeze dried and compressed to form transparent or translucent objects. The objects may, for example comprise blocks, bricks or other shapes that may be used in construction of buildings. Advantageously the carbonate compound may incorporate carbonate ions obtained by capture of carbon dioxide from an atmosphere of air, flue gas, exhaust gas or the like. Captured carbon may be sequestered in the objects indefinitely.

### CROSS-REFERENCE TO RELATED APPLICATION

This application claims priority from U.S. application No. 63/265,461 filed 15 Dec. 2021 and entitled TRANSLUCENT BULK CARBONATE AND ITS PRODUCTION which is hereby incorporated herein by reference for all purposes. For purposes of the United States of America, this application claims the benefit under 35 U.S.C. § 119 of U.S. application No. 63/265,461 filed 15 Dec. 2021 and entitled TRANSLUCENT BULK CARBONATE AND ITS PRODUCTION which is hereby incorporated herein by reference for all purposes.

### FIELD

This invention relates to translucent materials and methods and apparatus for producing such materials. In some embodiments the methods capture carbon compounds from the atmosphere or other source and sequester carbon in the produced materials. In some embodiments the produced materials are formed into useful objects of which building blocks and bricks are examples.

### BACKGROUND

There is a need to reduce the emission of CO₂ from human activities. Production of cement is a major source of emitted CO₂. The following references discuss the impact of CO₂ on world climate and the significance of cement production as a source of CO₂:
Rogelj, J., et al. Mitigation Pathways Compatible with 1.5° C. in the Co ntext of Sustainable Development. in Global Warming of 1.5° C. An IPCC Special Report on the impacts of global warming of 1.5° C. above pre-industrial levels and related global greenhouse gas emission pathways, in the context of strengthening the global response to the threat of climate change, sustainable development, and efforts to eradicate poverty pp. 93-174 (Cambridge University Press, 2018).
Kelemen, P. et al. An Overview of the Status and Challenges of CO2 Storage in Minerals and Geological Formations, Frontiers in Climate 1, 9 (2019)
Andrew, R. M. Global CO2 emissions from cement production, Earth System Science Data 10, 195-217 (2018).
Huntzinger, D. N. et al. A life-cycle assessment of Portland cement manufacturing: comparing the traditional process with alternative technologies J. Clean. Prod. 17, 668-675 (2009).

There is a need for commercially viable ways to sequester carbon.

Calcium carbonate (CaCO₃) has various forms. These include regular crystalline forms such as calcite. Calcium carbonate also has amorphous forms. Amorphous calcium carbonate is found in various biological systems. Amorphous calcium carbonate has some interesting physical properties. Significant research has been conducted regarding forms for calcium carbonate and amorphous calcium carbonate in particular. The following research papers discuss various properties of amorphous calcium carbonate:
Nobuyoshi Koga et al. Crystallization of amorphous calcium carbonate, Thermochimica Acta Vol. 318, Iss. 1-2, 7 Sep. 1998, pp. 239-244;
Ljerka Brecevic et al. Solubility of amorphous calcium carbonate, Journal of Crystal Growth 98 (1989) 504-510
Loste, Eva, et al. The role of magnesium in stabilising amorphous calcium carbonate and controlling calcite morphologies, Journal of Crystal growth 254, no. 1-2 (2003): 206-218.
Lam, Raymond S K, et al. Synthesis-dependant structural variations in amorphous calcium carbonate, CrystEngComm 9, no. 12 (2007): 1226-1236.
Ihli, Johannes, et al. Dehydration and crystallization of amorphous calcium carbonate in solution and in air, Nature communications 5, no. 1 (2014): 1-10.
Rodriguez-Blanco, J. D., et al. The role of pH and Mg on the stability and crystallization of amorphous calcium carbonate, Journal of Alloys and Compounds 536 (2012): S477-S479.
Günther, C., et al., Zeitschrift für anorganische und allgemeine Chemie 631, no. 13-14 (2005): 2830-2835.
Xu, Xurong, et al. Formation of amorphous calcium carbonate thin films and their role in biomineralization Chemistry of materials 16, no. 9 (2004): 1740-1746.
Huang, Shu-Chen, et al. A carbonate controlled-addition method for amorphous calcium carbonate spheres stabilized by poly (acrylic acid)s. Langmuir 23, no. 24 (2007): 12086-12095.
KOJIMA, Yoshiyuki, Akio et al. Synthesis of amorphous calcium carbonate and its crystallization Journal of the Ceramic Society of Japan 101, no. 1178 (1993): 1145-1152.
Gorna, K., et al. Amorphous calcium carbonate in form of spherical nanosized particles and its application as fillers for polymers Materials Science and Engineering: A 477, no. 1-2 (2008): 217-225.
Nudelman, Fabio, et al. Stabilization of amorphous calcium carbonate by controlling its particle size Nanoscale 2, no. 11 (2010): 2436-2439.
Alejandro Fernandez-Martinez et al. Pressure-Induced Polyamorphism and Formation of ‘Aragonitic’ Amorphous Calcium Carbonate 1 Jul. 2013: https://doi.org/10.1002/anie.201302974.
Ihli, Johannes, et al. The effect of additives on amorphous calcium carbonate (acc): janus behavior in solution and the solid state Advanced Functional Materials 23, no. 12 (2013): 1575-1585.
Ihli, Johannes, et al. Freeze-drying yields stable and pure amorphous calcium carbonate (ACC) Chemical Communications 49, no. 30 (2013): 3134-3136. Yoshino, Toru, et al. Pressure-induced crystallization from amorphous calcium carbonate Crystal growth & design 12, no. 7 (2012): 3357-3361.
Zhao Mu et al. Pressure-driven fusion of amorphous particles into integrated monoliths, Science 372, 1466-1470 (2021) 25 Jun. 2021.

The inventors have identified a need for ways to make useful objects that incorporate amorphous carbonates.

### SUMMARY

The present technology has a number of aspects. These include, without limitation:
methods for making translucent or transparent concrete materials;
methods for making bulk amorphous carbonates;
apparatus for making translucent or transparent concrete or amorphous bulk carbonate materials;
building bricks and blocks.
methods for making objects of amorphous carbonates such as calcium carbonate; and/or
apparatus for making objects of amorphous carbonates such as calcium carbonate.

Aspects of the invention involve making amorphous carbonate compounds (AC). The AC may be prepared by mixing a carbonate feed comprising an aqueous solution comprising carbonate (CO₃²⁻) and/or bicarbonate (HCO₃⁻) ions with a cation feed comprising cations and an additive feed comprising a stabilizing additive to yield a combined feed containing particles of an amorphous carbonate compound (AC).

In some embodiments, the carbonate feed is generated by capturing carbon dioxide from the atmosphere or flue gas. The carbonate feed may comprise high concentrations of carbonate ions and/or bicarbonate ions. In some embodiments, a combined concentration of carbonate ions and/or bicarbonate ions in the carbonate feed is in the range of about 0.01M to 2M. In some embodiments, the combined concentration of the carbonate ions and/or bicarbonate ions in the carbonate feed is greater than about 1M.

In some embodiments, the method comprises separating the particles of the AC from the combined feed and drying the separated particles of AC by freeze drying. The dried separated particles of AC may be placed into a mold or die. The separated particles of AC may be compressed by subjecting the particles to a pressure sufficient to bond the separated particles of AC together to form the object.

In some embodiments, the object is subjected to a drying step after being compressed. The drying step may remove surface moisture from the object. In some embodiments, the drying step comprises exposing the object to a temperature of less than about 60° C.

Aspects of the invention involve making bulk amorphous carbonate compounds. In some embodiments, greater than 1 gram, or in some embodiments, greater than 5 grams, or in some embodiments, greater than 10 grams, and in further embodiments, greater than 20 grams of amorphous carbonate may be produced by implementations of the present technology. In some embodiments, the amorphous structure of the bulk amorphous carbonate compounds produced by methods of the present technology is preserved. The bulk amorphous carbonate compounds produced by methods of the present technology may for example be transparent and/or translucent. The transparent and/or translucent appearance may in some embodiments be maintained for about seven days or more.

Aspects of the invention pertain to apparatuses for making translucent objects. The apparatus may comprise a mixer connected to receive a carbonate feed from a first feed source and a cation feed from the second feed source and to mix the carbonate feed and cation feed, a refrigerator operative to maintain a temperature in the mixer in an operating range, a solid/liquid separator connected to receive a combined feed from the mixer and to separate precipitated particles of amorphous carbonate (AC) from liquid constituents of the combined feed, a freeze drier connected to receive the separated precipitated particles of amorphous carbonate (AC) from the solid/liquid separator and to freeze dry the separated precipitated particles of AC, and a compression unit comprising a press and a mold or die. The compression unit may be operative to introduce the separated precipitated particles of AC into the mold or die and to compress the separated precipitated particles of AC to yield a translucent solid object having a form defined by a shape of the mold or die.

In some embodiments, a dryer is arranged downstream of the compression unit. The dryer may be operative to expose the object to a temperature. The temperature may be less than about 60° C. The dryer may be operative to remove surface moisture from the object.

Further aspects and example embodiments are illustrated in the accompanying drawings and/or described in the following description.

It is emphasized that the invention relates to all combinations of the above features, even if these are recited in different claims, illustrated in different drawings, and/or described in different sections, paragraphs or sentences.

### BRIEF DESCRIPTION OF THE DRAWINGS

The accompanying drawings illustrate non-limiting example embodiments of the invention.

FIG. 1 is a flowchart illustrating a method for producing a translucent material.

FIG. 2 is a schematic flow diagram illustrating apparatus for making the translucent material.

FIGS. 3A to 3D are photographs showing sample objects made of calcium carbonate by methods as described herein against a background of a card.

FIGS. 4A, 4B and 4C show a sample object made of bulk calcium carbonate with a thermochromic dye at various temperatures against a background of a card.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

This disclosure explains how useful objects may be made from amorphous carbonates. The carbonates may, for example be carbonates of an alkaline earth element such as calcium carbonate or magnesium carbonate. The description that follows describes implementations of the present technology that produce bulk amorphous calcium carbonate. For example, in some embodiments, greater than 1 gram, or in some embodiments, greater than 5 grams, or in some embodiments, greater than 10 grams, and in further embodiments, greater than 20 grams of amorphous calcium carbonate may be produced by implementations of the present technology. These implementations may be varied to produce other suitable amorphous carbonates.

Calcium carbonate may be crystallized to form a regular crystalline solid (e.g. calcite) but can also exist as an amorphous solid. The present technology includes processes for making objects which comprise amorphous calcium carbonate (ACC). The objects may be made to be translucent or transparent. A non-limiting example of an object that may be made using processes according to the present technology are building bricks or blocks which may be translucent or transparent.

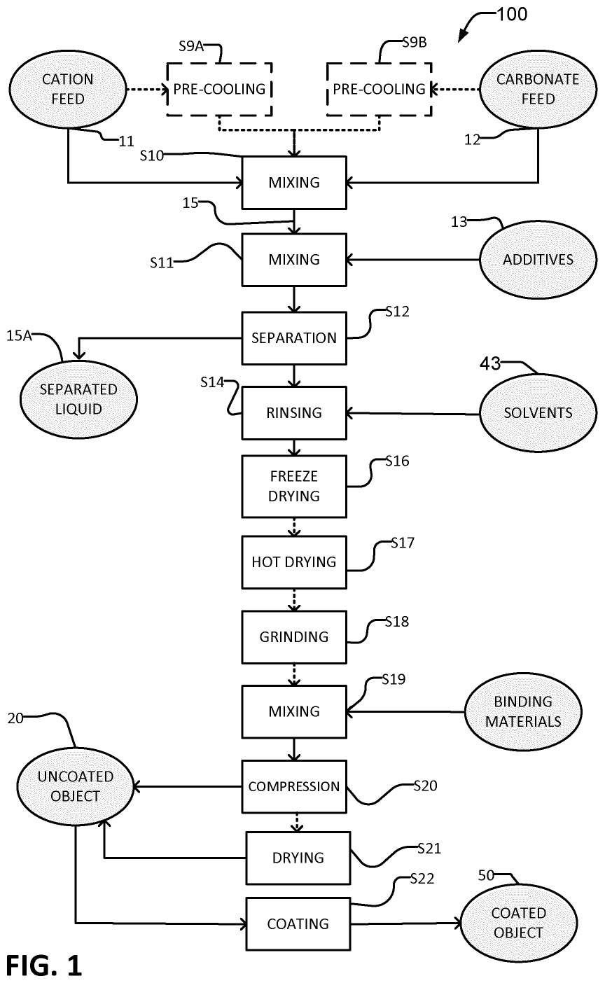

FIG. 1 is a flow chart that illustrates an example process 100 according to the invention. In step S10 particles of ACC are precipitated by mixing an aqueous solution 11 comprising calcium ions (Ca²⁺) (“cation feed 11”) with an aqueous solution 12 comprising carbonate or bicarbonate ions (“carbonate feed 12).

In some variations of process 100, solution 11 comprises other suitable cations such as Mg²⁺ instead of or in addition to calcium ions. The other ions may, for example, comprise cations of other alkaline earth metals.

Carbonate feed 12 may contain carbonate or bicarbonate ions having a combined concentration. The combined concentration of carbonate (CO₃⁻²) and bicarbonate (HCO₃⁻) may, for example be in the range of about 0.01M to about 2M or higher. In some embodiments, carbonate feed 12 has a combined concentration of carbonate and bicarbonate in the range of about 0.01M to 1M or about 0.1M to about 1M.

In some embodiments carbonate feed 12 is alkaline. For example, carbonate feed 12 may have a pH of at least 8 (e.g. a pH in the range of about 8 to about 14). Carbonate feed 12 may, for example, comprise a solution of an alkali hydroxide (e.g. potassium hydroxide—KOH) and/or an amine which also contains carbonate ions.

In some embodiments, carbonate feed 12 is a carbon capture solution (i.e. a solution in which carbon dioxide (CO₂) from the atmosphere and/or another source of CO₂ such as flue gas, combustion exhaust gases, or the like has been dissolved). The dissolved CO₂ may, for example be present in the form of some or all of carbonate ions, bicarbonate ions and dissolved CO₂ molecules.

Carbonate feed 12 may, for example, be generated by contacting a basic solution (for example, but not limited to, a KOH solution or a solution containing amine) with a gas containing CO₂ (for example, but not limited to, air, flue gas, exhaust gas etc.) in a suitable gas-liquid contactor. Suitable contactors for contacting gases and liquids are described in the patent and technical literature and are therefore known to those of skill in the art.

In some embodiments, high concentrations of solutions containing carbonate ions and/or bicarbonate ions (for example in the range of from about 0.1M to about 2M) may be generated from the carbon capture process. Such solutions may be used directly as carbon feed 12.

There are beneficial synergies associated with using a carbon capture solution for carbonate feed 12. These include:
Carbon capture solutions typically have compositions suitable for use as carbonate feed 12.
Objects made by process 100 can contain significant amounts of CO₂ (in the form of carbonate) and may keep that CO₂ out of the atmosphere for an extended time or permanently.
As described below, objects made by process 100 may be translucent or transparent. Such objects may have high value compared to building materials such as concrete and thus making such objects may have greater commercial viability.
In some embodiments, objects made by process 100 may displace building materials that require cement to make. Since cement production typically involves release into the atmosphere of large amounts of CO₂ the use of materials made by process 100 may provide significant benefits for our planet.

Cation feed 11 may, for example, comprise calcium ions having a concentration of 0.1M or higher. For example the concentration of calcium in cation feed 11 may be in the range of about 0.1 M to about 2 M or in the range of about 0.1M to about 0.5M. In some embodiments cation feed 11 is provided by an aqueous solution of calcium chloride.

The mixing in step S10 may comprise mixing cation feed 11 and carbonate feed 12 in a volumetric ratio in the range of about 1:20 to about 20:1. In some embodiment mixing step S10 involves supplying calcium ions in a stoichiometric excess for the reaction:

Ca⁺²+CO₃⁻²→CaCO₃ (1)

The mixing in step S10 is performed at a temperature that is above freezing temperatures of cation feed 11 and carbonate feed 12 and is low enough to promote precipitation of particles of ACC as opposed to a regular crystalline form of calcium carbonate. For example, in some embodiments, mixing step S10 is performed at a temperature in the range of about 0° C. to about 10° C.

In some embodiments cation feed 11 is pre-cooled at step S9A prior to mixing step S10. In some embodiments carbonate feed 12 is pre-cooled at step S9B prior to mixing step S10.

In some embodiments one or more additives 13 are mixed with cation feed 11 and carbonate feed 12 in mixing step S10 and/or mixed with a combined feed 15 resulting from the mixing of cation feed 11 and carbonate feed 12. In the illustrated embodiment, additives 13 are introduced in a separate step S11. Additive introduction step S11 may, for example, be performed in the range of 0 to 500 seconds after mixing step S10. In preferred embodiments the dwell between mixing step S10 and additive introduction step S11 is 60 seconds or less.

Non-limiting examples of additives 13 comprise one or more of:
polyacrylic acid (PAA) (e.g. PAA having a molecular weight in the range of 1200 to 100,000 g/mol),
other organic acids (e.g. citric acid, lactic acid, tartaric acid etc.),
sodium pyrophosphate tetrabasic (SPT),
polymers or biopolymers that provide enhanced functionality,
Mg²⁺
mixtures of two or more of the above.

For example, in some embodiments, additives 13 comprise PAA added in a mass ratio of PAA to the sum of CO₃²⁻ and HCO₃⁻ (the active reactants in carbonate feed 12) in the range of about 0.1:1 to about 3:1. As another example, in some embodiments, additives 13 comprise SPT added in a mass ratio of SPT to the sum of CO₃²⁻ and HCO₃⁻ (the active reactants in carbonate feed 12) of about 0.1:1 or more. Additives 13 may, for example inhibit nucleation of crystals of CaCO₃ (or another carbonate being produced) and/or inhibit growth of crystals of CaCO₃ (or another carbonate being produced).

Mixing step S10 preferably involves rapid mixing of cation feed 11 and carbonate feed 12 to form mixed feed 15. Rapid mixing may, for example be facilitated by stirring, flowing through an inline mixer which may comprise a static mixer or a mixer with a driven agitator, ultrasonic mixing etc. Rapid mixing of cation feed 11 and carbonate feed 12 creates a situation in which a solubility product [Ca⁺²][CO₃⁻²](where [Ca⁺²] and [CO₃⁻²] are respectively the concentrations of Ca⁺² and CO₃⁻² in mixed feed 15) significantly exceeds the value of the Kₛₚ for calcium carbonate under the conditions of mixing step S10. This in turn drives rapid precipitation of particles of ACC. The result of mixing step S10 may be a milky white suspension.

In separation step S12 the particles of ACC 17 are separated from the liquid 15A in which they formed. Separation step S12 may, for example comprise filtration and/or centrifugation.

In optional rinsing step S14 separated ACC 17 is rinsed in one or more non aqueous solvents 43. The solvent may, for example comprise acetone, methanol, ethanol, diethyl ether and/or other low-boiling point, non-aqueous solvents. Step S14 may comprise rinsing one or more times with one or more non-aqueous solvents.

After rinsing step S14 separated ACC 17 is subjected to a drying step S16. Drying step S16 removes moisture from the separated ACC. In some embodiments, drying step S16 comprises exposing the separated ACC to sub-freezing temperatures (e.g. temperatures of −30° C. or lower or −50° C. or lower or −80° C. or lower). In some embodiments the low temperatures are accompanied by reduced pressure (e.g. a partial vacuum). The inventors consider that freezing the separated ACC 17 (or exposing the separated ACC 17 to low temperatures) helps to stabilize the separated ACC 17. In some embodiments, water in the form of ice is removed from the frozen separated ACC 17 by exposing the ACC 17 to a temperature of not greater than about 20° C., or in some embodiments not greater than about 10° C. or in some embodiments not greater than about 5° C. The inventors believe that ACC may be sensitive to heat. Exposing the separated ACC 17 to high levels of heat may increase the rate of conversion of the separated ACC 17 to its crystalline form, and thus it may be preferable to maintain the temperature of the ACC 17 at a sufficiently low temperature, such as for example less than about 20° C., or less than about 10° C., or less than about 5° C. In some embodiments, it is preferable to shorten the amount of time at which the frozen separated ACC 17 is in its liquid phase. The inventors believe that the separated ACC 17 is sensitive to water. Long exposure of the separated ACC 17 to water may increase the rate of conversion of the ACC to its crystalline form. In some embodiments, the water in the form of ice may be removed from the frozen separated ACC 17 by sublimation, i.e., the direct conversion of ice to vapour without going through a liquid phase. The sublimation may be performed under reduced pressure, for example at a pressure in the range of about 20 Pa to about 100 Pa, or in some embodiments, in the range of from about 30 Pa to about 60 Pa, or in some embodiments, in the range of from about 40 Pa to about 60 Pa.

In some embodiments, drying step S16 comprises freeze-drying. The inventors consider that removing moisture from the separated ACC by freeze-drying allows for bulk processing of ACC, while preserving the amorphous structure of the processed ACC. In some embodiments, a batch comprising greater than about one gram of separated ACC is subjected to a freeze-drying step in drying step S16. In some embodiments, the batch comprises greater than about five grams of separated ACC, and in some embodiments, greater than about 10 grams of separated ACC, and in some embodiments, greater than about 20 grams of separated ACC. In optional “hot drying” step S17 more moisture is removed from the separated ACC by heating the separated ACC to a temperature in the range of about 20° C. to 200° C. in a low humidity atmosphere.

In optional step S18 the separated dried ACC is ground (e.g. in a ball mill, air mill, pin mill, media mill, hammer and screen mill, mortar and pestle, or the like.

In optional step S19 the separated dried ACC is mixed with a binder material.

In compression step S20 a die or mold is filled with the separated dried ACC. The die or mold may have any suitable size and shape. The separated dried ACC 17 is subjected to pressure in the die or mold. The applied pressure causes the particles of separated dried ACC to become bonded together to form a solid object 20 having a form determined by the shape of the die or mold.

Compression step S20 may, for example, comprise compressing the separated dried ACC using a press such as a hydraulic press, mechanical press, press rollers, or the like.

In some embodiments a pressure in the separated dried ACC is sufficient to cause object 20 to be translucent or transparent. In some embodiments the applied pressure is at least 0.01 GPa. For example, the pressure applied in step S20 may be in the range of about 0.1 GPa to about 2 GPa.

In some embodiments the pressure is applied slowly. In some embodiments, step S20 comprises applying pressure that increases at a rate of 0.05 GPa/second or less. In some embodiments step S20 comprises ramping applied pressure to a maximum applied pressure over a period of 5 seconds or more.

Step S20 may hold the applied pressure for a dwell time before releasing the applied pressure. In some embodiments the applied pressure is held for a dwell time of 10 seconds or more.

In some embodiments step S20 is performed in an air atmosphere. In some embodiments step S20 is performed in a protective atmosphere. The protective atmosphere may comprise a dry gas such as nitrogen, argon, or the like. Step S20 outputs object 20.

After compression step S20, object 20 may be subjected to an optional drying step S21. Optional drying step S21 may remove surface moisture from object 20. In some embodiments, drying step S21 comprises exposing object 20 to a drying temperature. The drying temperature is in some embodiments less than about 80° C., or in some embodiments, less than about 70° C., or in some embodiments less than about 60° C. In some embodiments, the drying temperature is in the range of from about 40° C. to about 70° C. Optional drying step S21 may be performed using any suitable dryer or heater, for example infrared heating or drying lamp, oven, and the like.

Optional coating step S22 applies a coating to the resulting object 50. A coating may block water or water vapour from contacting the material of object 20. A coating may optionally alter the appearance of object 20. Coating step S22 may, for example, comprise applying one or more coatings to object 20. Applied coatings may be water resistant or waterproof coatings. In some embodiments the coating(s) comprise a hydrophobic coating. In some embodiments the coating(s) are transparent or translucent. The coatings may, for example be clear.

Non-limiting examples of materials that may be applied to objects 20 as coatings include:
polytetrafluoroethylene (PTFE),
poly(methyl methacrylate) (PMMA),
epoxy including for example epoxy molding compounds,
Nafion™
   The coating may prevent water molecules from contacting ACC in the object. The coating may be transparent.

Coating step S22 may involve applying one or more coatings in any suitable way including, for example, dipping, spraying, powder coating, vacuum sputtering, etc.

Uncoated objects 20 may be kept transparent by storing them in a very dry atmosphere.

Method 100 may be performed as a batch process or as a continuous process.

Objects 20 may have any suitable shapes and sizes. For example, objects 20 may have the form of cubes, parallelepipeds, cylinders, discs, plates, embossed shapes, or any other shape in which the ACC may be adequately compressed by compression step S20 (e.g. any shape for which a suitable die or mold may be made).

Object 20 may have some or all of the following properties:
translucent at wavelengths of visible light,
transparent at wavelengths of visible light,
transparent to at least some infrared light (e.g. objects made of ACC tend to pass infrared light except at wavenumbers of about 860, 1090, and 1460 cm⁻¹),
dense (i.e. not porous),
hard,
mass density in the range of 1.3 to 2.5 g/cm³,
Young's modulus in the range of about 10 GPa to about 40 GPa,
a majority of object 20 by mass is ACC (or other suitable amorphous carbonate),
at least 30% of object 20 by mass is provided by captured CO₂.

In some embodiments object 20 is a brick and has standard dimensions for a brick. Table 1 provides dimensions for some example brick styles. Objects 20 may be bricks having a style and corresponding dimensions as shown in Table 1.

TABLE 1
Standard brick dimensions

| Brick Style | Standard Dimensions (inches) |
|---|---|
| Modular | 3 ⅝ × 2 ¼ × 7 ⅝ |
| Norman | 3 ⅝ × 2 ¼ × 11 ⅝ |
| Roman | 3 ⅝ × 1 ⅝ × 11 ⅝ |
| Jumbo | 3 ⅝ × 2 ¾ × 8 |
| Economy | 3 ⅝ × 3 ⅝ × 7 ⅝ |
| Engineer | 3 ⅝ × 2 13/16 × 7 ⅝ |
| King | 2 ¾ × 2 ⅝ × 9 ⅝ |
| Queen | 2 ¾ × 2 ¾ × 7 ⅝ |

In some embodiments object 20 have dimensions that are standard for glass blocks of the type that may be incorporated into a wall to let light pass through the wall. Examples of standard dimensions for glass blocks are provided in Table II. Objects 20 may have the form of blocks. The blocks may, for example have dimensions as indicated in Table 2.

TABLE 2
Example standard block Dimensions (inches)

9 ¼″ × 2 ⅛″ × 4 ½″
7 ¾″ × 7 ¾″ × 3 ⅞″
7 ¾″ × 7 ¾″ × 3 ⅛″
7 ¾″ × 7 ¾″ × 3″
7 ½″ × 7 ½″ × 3 ⅛″
5 ¾″ × 5 ¾″ × 3 ⅞″
5 ¾″ × 5 ¾″ × 3 ⅛″
5 ¾″ × 7 ¾″ × 3 ⅞″
5 ¾″ × 7 ¾″ × 3 ⅛″
4 ⅝″ × 2 ⅛″ × 4 ½″
3 ¾″ × 7 ¾″ × 3 ⅞″
3 ¾″ × 7 ¾″ × 3 ⅛″
3 ½″ × 7 ½″ × 3 ⅛″

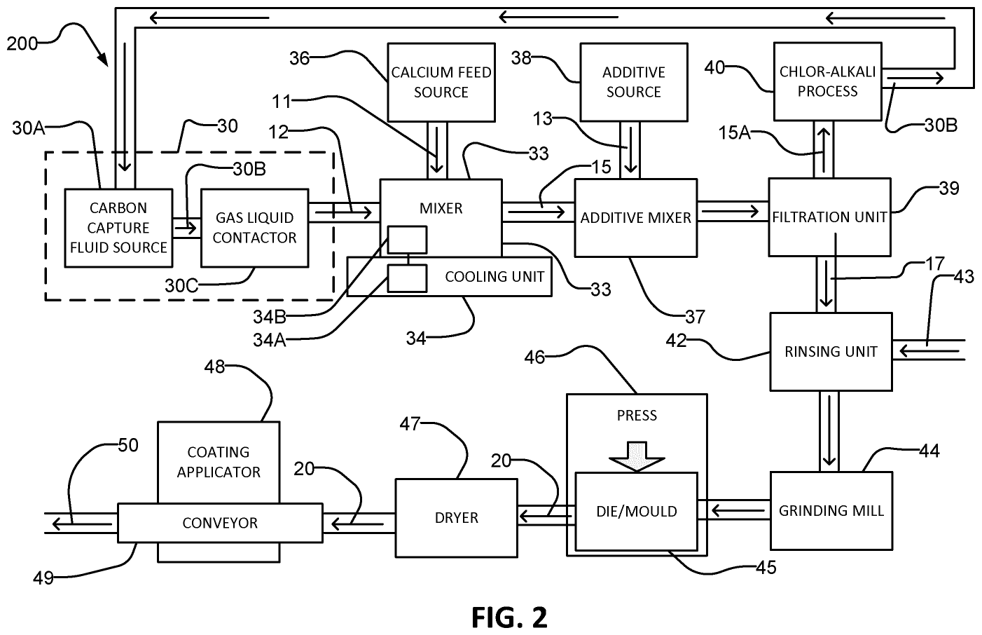

FIG. 2 is a schematic view showing apparatus 200 according to an example embodiment. Apparatus 200 may be arranged as a production line in which materials are carried from stage to stage by suitable conveyances such as pipes or conduits for liquid materials or slurries, conveyors of any suitable type (e.g. conveyor belts, screw conveyors, scoop conveyors, forced air conveyors or the like), delivery carts etc. for solid materials.

Apparatus 200 includes a carbon capture system 30. Carbon capture system 30 may perform direct carbon capture from an atmosphere containing carbon dioxide (e.g. air, flue gas, exhaust gas, etc.). In the depicted embodiment, carbon capture system 30 includes a source 30A of a carbon capture fluid 30B. Carbon capture liquid 30B may, for example comprise a basic solution such an aqueous solution of an alkali hydroxide such as KOH or an amine. Source 30A is connected to supply carbon capture liquid 30B to a gas liquid contactor 30C. At gas liquid contactor 30C, CO₂ gas is dissolved in carbon capture liquid 30B to yield carbonate source 12.

Carbonate feed 12 is delivered to mixer 33. A cooling unit 34 cools mixer 33 and/or materials being delivered to mixer 33. Cooling unit 34 may, for example, comprise a bath of coolant, one or more refrigerators, one or more heat exchangers. In the illustrated embodiment cooling unit 34 comprises a thermostat 34A which receives a temperature signal from a temperature sensor 34B and operates cooling unit 34 to maintain a set temperature in mixer 33. The set temperature may, for example be a temperature in the range of 0° C. to 10° C.

Apparatus 200 also includes a source 36 of cation feed 11. Source 36 may, for example comprise a source of an aqueous solution of a calcium salt (e.g. CaCl₂). Source 36 may, for example comprise a vessel or inline mixer into which the calcium salt is metered. Source 36 is connected to deliver the cation feed 11 to mixer 33.

In the illustrated embodiment, apparatus 200 includes an additive mixer 37 operative to mix one or more additives 13 into combined feed 15 output from mixer 33. Additive mixer 37 receives combined feed 15 and one or more additives 13 from an additive source 38. Additive source 38 may, for example comprise one or more metering pumps that deliver additives 13 into mixer 37. In addition to or as an alternative to introducing additives 13 at additive mixer 37, additives 13 may be added at mixer 33 or another location upstream from the indicated location of additive mixer 37.

Filtration unit 39 separates particles of calcium carbonate from combined feed 15 from liquid 15A in combined feed 15. Liquid 15A may, for example, comprise a solution of potassium chloride (KCl). In some embodiments liquid 15A is input to a chlor-alkali process 40 which regenerates capture fluid 30B.

Separated ACC 17 from filtration unit 39 is delivered to an optional rinsing unit 42 which washes separated ACC 17 with one or more non aqueous solvents 43. The rinsed separated ACC 17 is dried and delivered to an optional grinding mill 44. After grinding the separated ACC 17 is metered into a die or mold 45 and compressed by a press 46 to yield an object 20.

Dryer 47 may be arranged downstream of press 46 operative to expose object 20 to a temperature. The temperature may be less than about 60° C. In some embodiments, the temperature is in the range of from about 40° C. to about 70° C. Dryer 47 may be operative to remove surface moisture from object 20.

Apparatus 200 includes a coating applicator 48 operative to apply a moisture barrier coating to object 20. Apparatus 200 may, for example, comprise a conveyor system 49 that carries objects 20 through coating applicator 48.

The completed objects 20 may, for example, comprise bricks that may be incorporated into structures such as buildings.

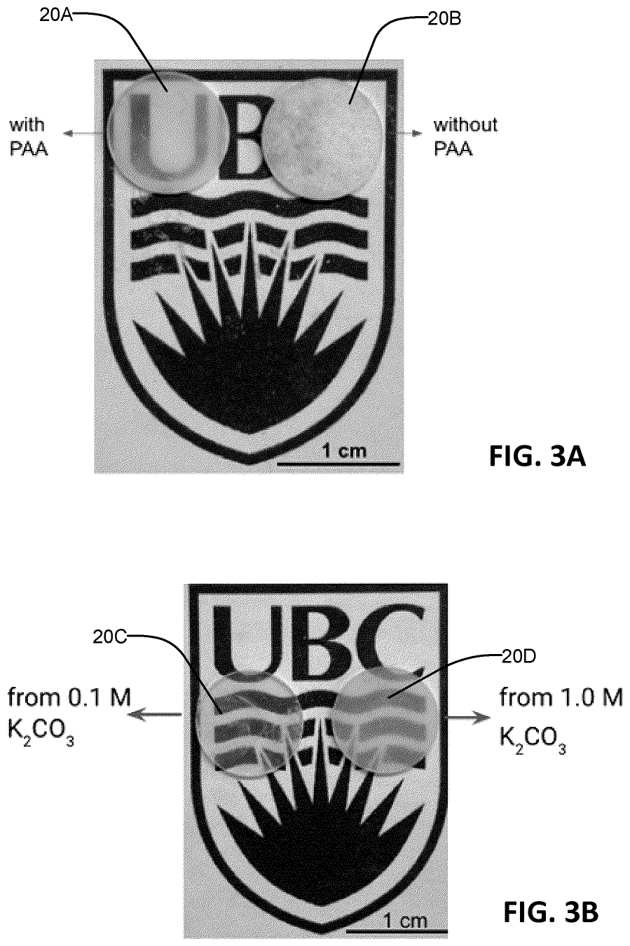

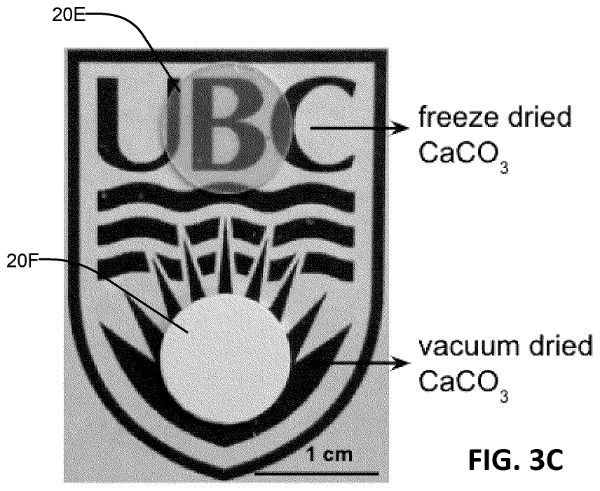

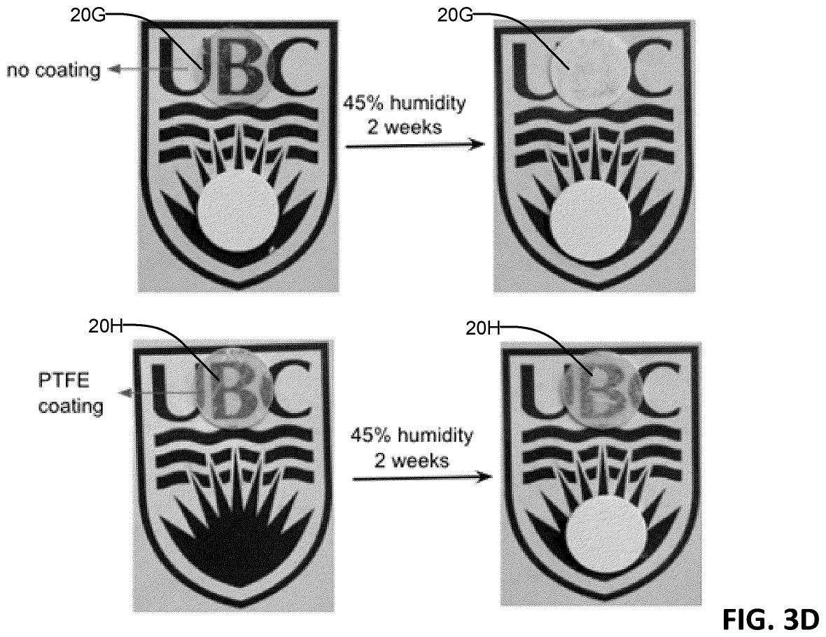

FIGS. 3A to 3D are photographs showing example objects 20 made in experiments designed to explore the effect on properties of objects 20 of various parameters of process 100. In each case, process 100 was performed as a batch process and objects 20 were formed in a die shaped so that the object has the form of a flat circular disc.

### Experiment 1

FIG. 3A shows objects 20A and 20B that demonstrate the effect of adding PAA as an additive 13 on transparency. Objects 20A and 20B were fabricated using as carbonate feed 12: 100 ml 0.1 M K₂CO₃ and, as cation feed 11: 100 ml 0.1 M CaCl₂ solution. Objects 20A and 20B were each pressed at a pressure of 2 GPa. The only difference in the processes used to make objects 20A and 20B is that PAA was added as an additive 13 in process 100 for making object 20A (0.1 g PAA was added 90 seconds into the low-temperature mixing step) and no PAA was added when object 20B was made. It can be seen that object 20A is transparent while object 20B is not transparent.

Another experiment used SPT as an additive 13. In that experiment it was found that the object 20 for which SPT was introduced as an additive 13 was transparent.

### Experiment 2

Experiment 2 investigated the effect of the concentration of carbonate in carbonate feed 12. FIG. 3B shows objects 20C and 20D. Object 20C was made in the same manner as object 20A. Object 20D differed in that the carbonate feed 12 was provided by: 10 ml 1 M K₂CO₃. Objects 20C and 20D were both transparent. However, object 20D had a slightly lower transparency than object 20C.

### Experiment 3

Experiment 3 investigated the effect of substituting vacuum drying for freeze drying. For small batches of separated ACC 17 (<2 g) no significant differences in the properties of objects 20 were observed. However, for larger batches of separated ACC (>2 g) objects 20 made from separated ACC 17 dried using freeze drying tended to be more transparent than objects 20 made from separated ACC 17 dried using vacuum drying. FIG. 3C shows objects 20E and 20F. Object 20E was produced in the same manner as object 20A. Object 20F was produced in the same manner as object 20E except that vacuum drying was used instead of freeze drying to dry the separated ACC 17. It can be seen that object 20E is transparent whereas object 20F appears to be opaque. The inventors consider that freeze drying separated ACC 17 is beneficial, especially in large scale (e.g. industrial) applications, because freeze drying may remove water more effectively while preserving the structure of the separated ACC 17.

### Experiment 4

Experiment 4 investigated the effect of moisture on objects 20 after they were made. FIG. 3D shows objects 20G and 20H. Each of objects 20G and 20H were made in the same manner as object 20A. Object 20G had no coating. Object 20H was coated with a coating of polytetrafluoroethylene (PTFE). The coating was Polytetrafluoroethylene (PTFE, 60 wt %) suspension purchased from Sigma Aldrich.

Objects 20G and 20H were each kept in an atmosphere having 45% humidity for 2 weeks. During the 2 week exposure the transparency of object 20G gradually decreased until object 20G was essentially opaque. By contrast, object 20H remained transparent at the end of the 2 week exposure.

The experiment was also performed using a coating made by applying a Nafion™ perfluorinated resin solution (5 wt % in mixture of lower aliphatic alcohols and water) purchased from Sigma Aldrich. This coating also resulted in preservation of the transparency of a coated object 20.

### Experiment 5

Experiment 5 investigated the effect of exposing object 20 to a temperature in drying step S21 after compression step S22. In one experiment, an object was exposed to a temperature of less than 60° C. using an infrared lamp immediately after compression. The object remained transparent for over 10 days after drying without any further treatment. These results suggest that regular heat treatment, such as approximately weekly, may help maintain the transparency of the object. In another experiment, an object 20 was exposed in an oven to a temperature of over 60° C. immediately after compression. The object turned opaque within three days after heating. In a further experiment, an object 20 was not exposed to heat after compression step S22. The object was stored in a glove box within which the object was exposed to air in a water-free environment. The transparency of the object continued to gradually decrease three months after compression.

### Example Application—Thermochromic Objects

In an example application, objects 20 include one or more thermochromic (temperature-responsive) dyes. With the inclusion of such dyes the optical transmission properties of objects 20 can be made highly temperature dependent. One application of such objects is the control of solar transmission through concrete walls. For example, objects 20 may comprise bricks or windows incorporated in concrete walls. A building made of this thermochromic smart concrete can switch to a darker color when the ambient temperature is low to confine the heat within the building, and to a light color when the ambient temperature is high (e.g. >31° C.) to release excess heat.

Such objects may be used to reduce building energy consumption. For example, the objects may be more transparent to light at higher temperatures and less transparent to light at lower temperatures.

One or more thermochromic dyes may be incorporated in objects 20, for example, by mixing the thermochromic dye(s) with separated ACC particles before pressing the particles to form an object 20. Such dye(s) may be distributed throughout an object 20 or may be confined to a layer within or at a surface of the object 20.

A wide variety of suitable thermochromic dyes is available commercially. TFor example, temperature-responsive dyes (black, gold, green and red) are available from Uniglow Products LLC.

One example is a black-white temperature-responsive dye which is black in colour at temperatures below a transition temperature and is clear or white at temperatures above the transition temperature. The transition temperature may, for example, be about 30° C. Dyes having other colors (e.g. red, gold, green) and/or different transition temperatures all can be employed in the present technology. The dye(s) may be selected based on the application.

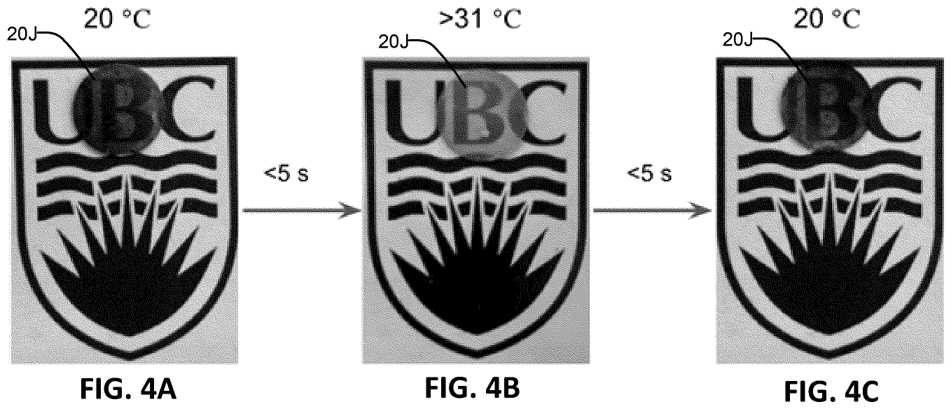

FIGS. 4A, 4B and 4C respectively show an example object 20J which incorporates such a dye having a transition temperature of 31° C. at 20° C., after heating to a temperature above 31° C. and after cooling back to 20° C. Object 20J included 5 wt % of the dye. The mixture of ACC 17 and dye was pressed to form object 20J at a pressure of 1 GPa for 10 s.

FIG. 4A shows that the thermochromic concrete of object 20J shows a dark color at 20° C., and then switches to significantly higher transparency when the temperature is raised to >31° C. This transition takes less than 5 seconds. The process is reversible when the temperature goes down to 20° C.

The inventors have experimented with including dye in objects 20 in a wt % range of 0.1-20 wt %. The amount of dye added may be selected to achieve desired light transmission at selected temperatures.

The present technology may be varied in a range of ways. For example:
other suitable cations (e.g. cations of other alkaline earth elements) may be substituted for Ca²⁺ to yield amorphous carbonates); and/or
other suitable solvents in which the precipitated amorphous carbonate has low solubility and its constituents (cations, carbonate and/or bicarbonate) are sufficiently soluble may be substituted for aqueous solvents in carbonate feed 12 and/or cation feed 12.

Where a component (e.g. a mixer, cooler, pump, press, die, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;

in some embodiments the numerical value is in the range of 9.5 to 10.5; and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method or process can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A process for making translucent objects, the process comprising:
mixing a carbonate feed comprising an aqueous solution comprising carbonate (CO₃²⁻) and/or bicarbonate (HCO₃⁻) ions with a cation feed comprising cations and an additive feed comprising a stabilizing additive to yield a combined feed containing particles of an amorphous carbonate (AC) compound;
separating the particles of amorphous carbonate (AC) from the combined feed;
freeze drying the separated particles of AC; and
placing a quantity of the separated particles of AC into a mold or die and subjecting the separated particles of AC to a pressure sufficient to bond the separated particles of AC together to form the object.

2. The method according to claim 1 comprising generating the carbonate feed by capturing carbon dioxide from the atmosphere or flue gas.

3. The method according to claim 2 wherein capturing carbon comprises contacting an aqueous basic solution with the atmosphere or flue gas in a gas-liquid contactor.

4. (canceled)

5. The method according to claim 1 comprising drying the separated particles of AC to a temperature after subjecting the separated particles of AC to the pressure sufficient to bond the separated particles of AC together to form the object, wherein the temperature is less than about 60° C.

6. (canceled)

7. The method according to claim 1 comprising rinsing the separated particles of AC in a non-aqueous solvent before freeze drying the separated particles of AC.

8. The method according to claim 1 wherein the cations comprise calcium ions (Ca²⁺) and the amorphous carbonate (AC) comprises amorphous calcium carbonate (ACC).

9. The method according claim 8 wherein the cation feed comprises an aqueous solution of calcium chloride (CaCl₂).

10. The method according to claim 8 wherein a concentration of the calcium ions in the cation feed is in the range of about 0.01 M to 2M.

11. (canceled)

12. The method according to claim 1 wherein a combined concentration of the carbonate ions and the bicarbonate ions in the carbonate feed is in the range of about 0.01 M to 2M.

13. (canceled)

14. The method according to claim 1 wherein the additive is selected from the group consisting of:
an organic acid,
sodium pyrophosphate tetrabasic (SPT),
a polymer or biopolymer,
magnesium ions (Mg²⁺), and
mixtures of any two or more of the above.

15. (canceled)

16. The method according to claim 1 further comprising coating the object with a waterproofing coating, wherein the waterproofing coating is one or both hydrophobic and clear at visible light wavelengths.

17. The method according to claim 16 wherein the waterproofing coating comprises a coating of a material selected from the group consisting of:
polytetrafluoroethylene (PTFE),
poly(methyl methacrylate) (PMMA);
epoxy; and
Nafion™.

18.-19. (canceled)

20. The method according to claim 1 wherein the mixing is carried out at a temperature in the range of about 0° C. to about 10° C.

21. The method according to claim 1 comprising mixing a thermochromic dye with the separated particles of ACC prior to subjecting the separated particles of ACC to the pressure, wherein the thermochromic dye makes up 0.1-20 wt % of the mixture of the thermochromic dye and the separated particles of AC.

22. The method according to claim 21 wherein the thermochromic dye is more light-absorbing below a threshold temperature and is less light-absorbing above the threshold temperature, wherein the threshold temperature is in the range of 20° C. to 40° C.

23.-29. (canceled)

30. The method according to claim 1 wherein the object has one or more of the following properties:
the object has the form of a rectangular parallelepiped;
the object is translucent to visible light;
the object is transparent to visible light;
the object is dense (i.e. not porous);
the object is hard;
a majority of the object by mass is AC; and
at least 30% of a mass of the object is captured CO₂.

31. An apparatus for making translucent objects, the apparatus comprising:
a mixer connected to receive a carbonate feed comprising an aqueous solution comprising carbonate (CO₃²⁻) and/or bicarbonate (HCO₃⁻) ions, a cation feed, and an additive feed comprising a stabilizing additive and to mix the carbonate feed and cation feed with the additive feed comprising the stabilizing additive to yield a combined feed containing particles of an amorphous carbonate (AC) compound;
a solid/liquid separator connected to receive the combined feed from the mixer and to separate the particles of AC from liquid constituents of the combined feed;
a freeze drier connected to receive the separated particles of AC from the solid/liquid separator and to freeze dry the separated particles of AC; and
a compression unit comprising a press and a mold or die, the compression unit operative to introduce a quantity of the separated particles of AC into the mold or die and to subject by compressing the separated particles of AC to a pressure sufficient to bond the separated particles of AC together to form the object.

32. (canceled)

33. The apparatus according to claim 31 further comprising a rinsing unit located in a feed path between the solid/liquid separator and the freeze drier, the rinsing unit operative to rinse the separated particles of AC in non-aqueous solvent before freeze drying the separated particles of AC.

34. (canceled)

35. The apparatus according to claim 31 comprising a coating unit operative to coat the objects by applying a waterproofing coating to the objects produced by the compression unit.

36. The apparatus according to claim 31 wherein the carbonate feed is supplied from a first feed source, and wherein the first feed source comprises a carbon capture system operative to generate the carbonate feed, the carbon capture system comprising a liquid gas contactor located to capture carbon dioxide from an atmosphere of air, flue gas or exhaust gas.

37.-38. (canceled)

39. The apparatus according to claim 31, further comprising a refrigerator operative to maintain a temperature in the mixer in an operating range of about 0° C. to about 10° C., thereby the mixing of the carbonate feed and the cation feed with the additive feed is carried at the temperature.
